(19) United States
(12) Patent Application Publication
(10) Pub. No.: US 2022/0200400 A1
(43) Pub. Date: Jun. 23, 2022

(54) Oscillation Excitation Device for Producing Oscillations and/or Vibrations

(71) Applicant: Wacker Neuson Produktion GmbH & Co. KG, Reichertshofen (DE)

(72) Inventor: Michael Steffen, Munich (DE)

(21) Appl. No.: 17/600,714

(22) PCT Filed: Mar. 30, 2020
(86) PCT No.: PCT/EP2020/058911

§ 371 Date: Oct. 1, 2021

(30) Foreign Application Priority Data
Apr. 2, 2019 (DE) 10 2019 108 503.9

(51) Int. Cl. H02K 7/06; H02K 7/08

(52) U.S. Cl. CPC H02K 7/063; H02K 7/08

(57) ABSTRACT

An oscillation excitation device for producing oscillations and/or vibrations includes an electric motor which has a stator unit and a rotor unit that can be rotated about an axis of rotation and has at least one rotor shaft. At least a first bearing unit and a second bearing unit are provided for rotatably mounting the rotor shaft and/or rotor unit. At least one electromagnetic drive system of the electric motor is arranged between the first bearing unit and the second bearing unit. At least one rotatable imbalance unit is provided for producing an imbalance. The imbalance unit is arranged, at least in part, between the first bearing unit and the second bearing unit.

### BACKGROUND OF THE INVENTION

### 1. Field of the Invention

The invention relates to an oscillation excitation device for producing oscillations and/or vibrations, wherein an electric motor having a stator unit and having a rotor unit which is rotatable about a rotation axis and which has at least one rotor shaft.

### 2. Discussion of the Related Art

Various oscillation exciters are used in the most diverse variants and in widely different technical fields of application. For example, so-called external vibrators are already known in the construction sector, said external vibrators being fastened to the formwork in order for the concrete to be compacted when casting concrete.

Electric motors have usually been used to date, the motor shaft of the electric motors at both ends being routed to the outside through the motor housing i.e. so-called bearing brackets. Imbalance weights which in the operation of the motor cause a vibration in particular of the vibrator, or of the formwork or the like, are in each case placed only at one end or at both ends of the shaft. The imbalance weights have a center of gravity which is eccentric in terms of the rotation axis, this causing/generating the vibration or oscillation, respectively. The bearings here, in particular the roller bearings for mounting driveshaft which are disposed in the so-called bearing brackets are to be sized so as to be correspondingly stable. For safety reasons, or in order to be protected against contact, water, dirt, etc., the imbalance weights are disposed within corresponding housings or casings or covers, respectively. A corresponding external vibrator is known from DE 20 2006 001 445, for example.

However, the complexity in terms of construction and thus also economy is disadvantageous here. Said complexity is very high above all for a dirt-tight and above all water-tight embodiment of a high protection class for uses in the external sector, etc., wherein leakages in practice did arise again and again specifically also in the case of repair work, for example damaged casings of the imbalance weights, such that ingressing dirty water would compromise or even destroy the motor or the electromagnetic drive system, respectively.

### SUMMARY

In contrast, it is an object of the invention to propose an oscillation excitation device for producing oscillations and/or vibrations, said device at least in part eliminating the disadvantages of the prior art, in particular enabling a cost-effective production and/or operating mode.

Proceeding from an oscillation excitation device of the type mentioned at the outset, this object is achieved by providing an oscillation excitation device for producing oscillations and/or vibrations that comprises an electric motor and at least first and second bearing units. The electric motor has a stator unit and a rotor unit which is rotatable about a rotation axis and which has at least one rotor shaft. The first bearing unit and the second bearing unit are configured to rotatably support at least one of the rotor shaft and the rotor unit. The electric motor has at least one electromagnetic drive system that is disposed between the first bearing unit and the second bearing unit. At least one rotatable imbalance unit is provided that is configured to produce an imbalance. The imbalance unit is disposed, at least in part, between the first bearing unit and the and the second bearing unit.

The disposal of the imbalance unit within, or between the bearing units or the bearings/bearing brackets of the electric motor, respectively, represents a total departure from the practice that has proven successful over decades. Imbalances which are disposed outside the bearings can thus be partially or preferably completely dispensed with, this significantly reducing the complexity in terms of construction and thus also economy, on the one hand. By virtue of the dispensable or omitted external imbalances, protective covers or the like which protect the imbalances in relation to dirt or contact, etc., and the corresponding production steps can be entirely dispensed with. Consequently, sealing these covers/lids in relation to ingress of water, dust or the like is also dispensed with. Accordingly, the risk of a leakage of the imbalance covers or lids, respectively, being generated during repair work or maintenance is reduced. The operational reliability and the service life is thus also improved or increased, respectively.

Moreover, the oscillation excitation device can be constructed in a substantially more compact or space-saving manner, respectively. The installation space required to date for the imbalance or the imbalance weights, respectively, outside the bearing units or of the electromagnetic drive system, respectively, can be partially or preferably entirely dispensed with. The motor shaft, or the driveshaft, respectively, can be embodied in a correspondingly small or short manner, respectively.

In general, an overall minor total weight can be realized according to the invention, because additional/separate (external) imbalance units or imbalance elements, respectively, are advantageously dispensable or not used, respectively. According to the invention however, the rotor unit or rotor shaft, respectively, which to date has in most instances being configured in a relatively solid manner, for producing the imbalance now can specifically be configured so as to be at least partially hollow, that is to say in the regions without material/metal/steel, and thus be filled with air. Accordingly, a reduction of the total weight of the device according to the invention can be realized in comparison to the prior art, while having an almost identical imbalance mass or an oscillation/vibration output, respectively. At an oscillation/vibration output which is approximately identical in comparison to the prior art, a saving of energy and/or a reduction in the size of the electromagnetic drive system can thus be achieved.

At least one imbalance element of the imbalance unit is preferably disposed within the rotor or the rotor unit, respectively, and/or within a rotor shaft which is at least in part configured as a hollow shaft. This means that the imbalance element, or the imbalance unit, respectively, is situated within the rotor unit and/or the rotor shaft, or inside the rotor unit and/or the rotor shaft, respectively. Rotor components of the electromagnetic drive system such as, for example, permanent magnets or electrical coils or the like, here can advantageously at least in part be disposed on the circumference, or externally, respectively about the imbalance element or of the imbalance unit, respectively. This enables a particularly compact construction mode having in some instances a high-output drive system, or an electromagnetic drive system having a relatively high torque, respectively. Moreover, a largely closed system having an integrated imbalance unit can be realized here.

The rotor shaft is advantageously configured as an imbalance unit. This enables a particularly minor complexity in terms of construction and economy in order for the device according to the invention to be produced. Moreover, a very compact and closed construction mode can be realized, this improving the operational reliability and the power density.

In one preferred refinement of the invention the rotor unit has at least one support unit for supporting rotor components of the electromagnetic drive system such as, for example, electromagnetic coils and/or permanent magnets (comprising rare earths). For example, the support unit is disposed on the rotor shaft. The support unit preferably comprises (numerous) laminated cores and/or the support unit is advantageously configured so as to be partially hollow or with recesses, respectively. A cost-effective and compact device can be realized here. The cavities and/or recesses of the support unit generate the imbalance according to the invention, or lead to a center of gravity (mass) of the support unit and/or the rotor unit that is disposed so as to be eccentric to or offset from, respectively, the rotation axis of the rotor unit. The support unit can thus be advantageously configured as an imbalance unit.

In one preferred variant of the invention the imbalance unit is disposed at least within a motor housing of the electric motor. A largely closed system having an integrated imbalance unit can thus be realized here, said system being advantageously largely enclosed or encased, respectively, by the motor housing and optionally including the bearing brackets. Separate protective covers outside the motor housing or the bearing brackets, respectively, as in the prior art, can be dispensed with. In terms of construction and economy, this can be realized with a particularly minor (production) complexity.

The imbalance unit preferably comprises at least one first eccentric element, wherein a first spacing between a first center of gravity of the first eccentric element and the rotation axis is provided. At least one advantageous adjustment unit for varying the first spacing between the first center of gravity of the first eccentric element and the rotation axis is in particular provided here. An adaptation or variation, respectively, of the effective imbalance mass can thus be advantageously implemented. For example, an enlargement and/or a reduction of the effective imbalance mass, or of the eccentricity of the imbalance unit or of the imbalance element, respectively, can be realized by way of the advantageous adjustment unit. This can be a great advantage for a start-up phase of the motor, for example, and/or for an upper operating range at an almost maximum rotating speed of the motor.

In one preferred embodiment of the invention the adjustment unit comprises at least one restoring spring element for producing a restoring force which is at least in part radially aligned and acts on the first eccentric element.

The imbalance unit advantageously comprises at least the first eccentric element and a second eccentric element which has a second center of gravity, wherein the second center of gravity is at least temporarily disposed so as to be different from the first center of gravity of the first eccentric element. For example, the adjustment unit varies/adjusts the first and/or the second center of gravity, in particular relative to one another. The effective imbalance mass can also be varied herewith, and an enlargement and/or a reduction of the effective imbalance mass or of the eccentricity of the imbalance unit or of the imbalance elements/eccentric elements, respectively, can thus be realized. This can be in turn a great advantage for a start-up phase of the motor and/or for an upper operating range at an almost maximum rotating speed of the motor, for example.

In one advantageous variant of the invention the first eccentric element/imbalance element and/or the second eccentric element/imbalance element are/is configured as an eccentric element/imbalance element which is rotatable about the rotation axis and/or the rotor shaft. The effective imbalance mass can also be advantageously varied herewith, and an enlargement and/or a reduction of the effective imbalance mass or of the eccentricity of the imbalance unit or of the imbalance element(s)/eccentric element(s), respectively, can thus be realized.

Moreover, the eccentric element/imbalance element which is rotatable about the rotation axis and/or the rotor shaft can be configured as an eccentric element/imbalance element which is dependent on the rotating direction. For example, a first rotating direction of the rotor unit and/or the imbalance unit can advantageously enlarge the effective imbalance mass, and a second rotating direction (counter to the first rotating direction) of the rotor unit and/or the imbalance unit can advantageously reduce the effective imbalance mass.

At least one detent element is advantageously provided as a detent for the eccentric element/imbalance element which is rotatable about the rotation axis and/or the rotor shaft. This measure enables the eccentric element/imbalance element which is rotatable about the rotation axis and/or the rotor shaft to be positioned in a defined manner such that a defined effective imbalance mass can advantageously be adjusted, in particular during the operation of the motor, that is to say during the rotation of the rotor unit.

Advantageous uses of a device according to the invention can be, for example, for compacting soil or concrete engineering or construction site engineering or foundry technology or sorting objects. Moreover, other/further advantageous uses can also be readily realized.

According to the invention, the imbalances or imbalance elements, respectively, at the free shaft ends of the (vibrator) motors can in principle be dispensed with without substitution, wherein the effect of said imbalances or imbalance elements, respectively, is advantageously relocated to the rotor or the rotor unit, respectively. The rotor as a result of advantageous measures is conceived for masses that act eccentrically in relation to the motor shaft of said rotor and can display the effect of said rotor in a system which is preferably constructed so as to be completely closed. Dispensing with conventional imbalance disks or imbalance masses, etc., according to the prior art renders the oscillation excitation device, or the vibrator, respectively, compact and extremely cost-effective because a major part of the production steps processing steps, respectively, is advantageously dispensed with. Realized is a “imbalanced” electric motor, so to speak, which can be implemented in the highest protection class. Malfunctions or faults, respectively that is to say the ingress of water, smashed housing protective covers, etc., as in the prior art are (almost) no longer possible.

In general, all presently commercially available motor technologies can be used, such as a synchronous machines, for example, which are preferred due to the simplicity thereof, or the minor complexity in terms of the construction thereof, respectively, and the minor costs. However, magnet motors, switch reluctance motors, synchronous reluctance motors, or external rotor motors or internal rotor motors, respectively, can also be used for example.

It is furthermore possible according to the invention for the oscillation exciters or vibrators, respectively, additionally to the imbalance installed in the rotor, to be equipped with additional weights within and/or outside the vibrator so as to decrease or amplify the effect of the latter.

Advantageous additional weights are thus also possible within the rotor, for example, said additional weights, counter to springs, elastomer elements or the like, moving radially outward as the rotating speed increases and thus (gradually) reducing (so-called “opposite approach”) or amplifying the effect of the oscillation exciter or of the vibrator, respectively, for example for an easier start-up of the motor. A separate additional weight, or an adjustable imbalance element, respectively in the rotor, or in a less preferred construction mode outside the vibrator, that is to say at one or both shaft ends, can be used for reinforcing or reducing the installed imbalance mass, depending on the rotating direction.

In general, the rotor or the rotor unit, respectively, according to the invention can temporarily or entirely assume the function of the eccentrics which to date, or conventionally, respectively, have being attached externally on the shaft ends.

In principle, the combination of the relevant components leads to an advantageously closed unit in which the rotor assumes the function of the eccentrics/imbalance, this leading to a drastic simplification of the oscillation exciters according to the invention and to significantly reduce complexity, in particular in conjunction with an elimination of many complex and expensive operating steps in the production of electrical oscillation exciters according to the invention. Moreover, the ruggedness is enhanced, and defects as a result of environmental influences are moreover largely eliminated.

### BRIEF DESCRIPTION OF THE DRAWINGS

An exemplary embodiment of the invention is illustrated in the drawing and will be explained in more detail hereunder by means of the figures in which:

FIG. 1 shows a schematically illustrated cross section through a first electric motor, configured as an asynchronous motor, according to the invention;

FIG. 2 shows a schematically illustrated cross section through a second electric motor, configured as an asynchronous motor, according to the invention;

FIG. 3 shows a schematically illustrated cross section through a third electric motor, configured as a synchronous motor, according to the invention;

FIG. 4 shows a schematically illustrated cross section through a fourth electric motor, configured as an asynchronous motor, according to the invention, having a separate, radially adjustable imbalance weight;

FIG. 5 shows a schematically illustrated cross section through a fifth electric motor, configured as an asynchronous motor, according to the invention, having a separate imbalance weight which is rotatable about the rotation axis and is illustrated in two different detent positions; and

FIG. 6 shows a schematically illustrated longitudinal section through a sixth electric motor according to the invention, having two imbalance weights which are disposed on the rotor shaft so as to be on both sides of the drive system of the rotor.

### DETAILED DESCRIPTION

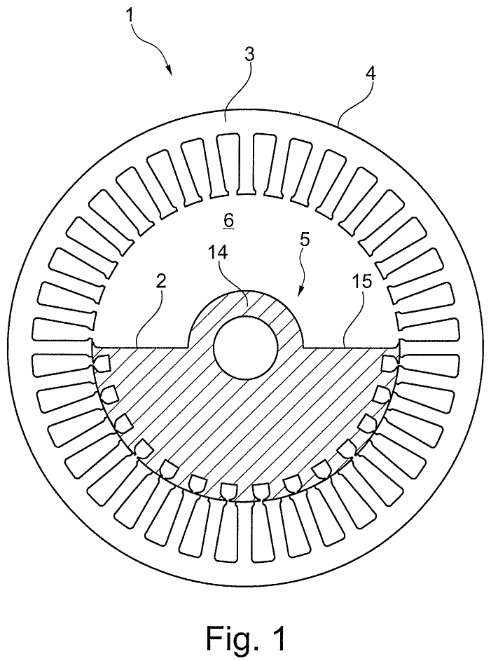

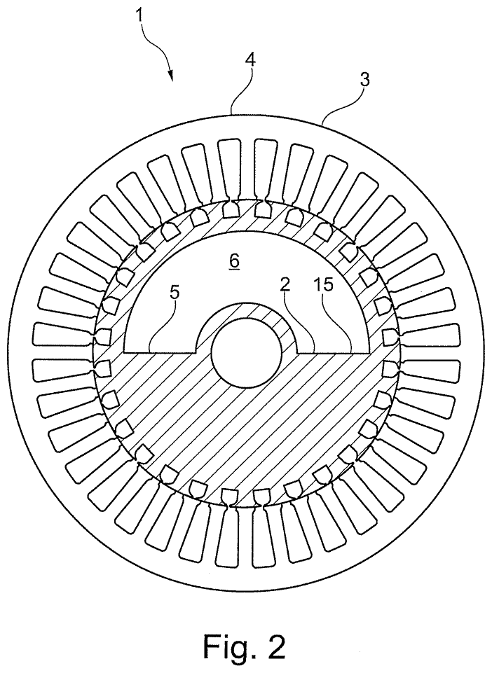

Various electric motors 1 according to the invention in FIGS. 1 to 6 are illustrated in a schematic manner and perpendicular to the rotation axis in a cross section through an electromagnetic drive system of the motor 1, the latter being generally known and not illustrated in more detail. The electric motor 1 comprises substantially a rotor 2 and a stator 3 which has an outer a motor housing 4. The rotor 2, for example according to the figures, is configured in such a manner that said rotor 2 comprises a rotor shaft 16, or a rotor shank 14, respectively, and a support 15 for the electromagnetic drive components.

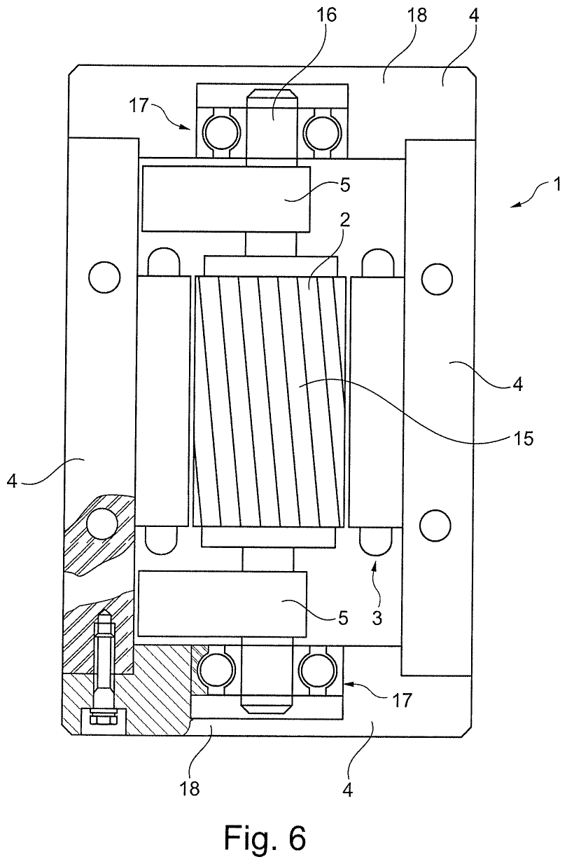

The stator 3 in a manner known moreover comprises two so-called bearing brackets 18 (cf. FIG. 6) which are disposed along the rotation axis and on both sides of the electromagnetic drive system, one bearing unit 17, or advantageously one or two roller bearings 17 for mounting the rotatable rotor 2, respectively, being in each case disposed in said bearing brackets 18. The bearing brackets 18, or bearing receptacles 18, respectively, in the context of the invention are a component part of the motor housing 4 such that a completely closed-off motor housing 4 in the context of the invention is realized. As a result, the ingress of dirt, dust and water can particularly effectively advantageously be prevented, as a result of which high requirements in terms of the safety and the service life of the motor 1 can be met.

In both variants of FIGS. 1 to 6, the rotor 2 at the same time is advantageously configured as an imbalance unit 5 according to the invention, or the imbalance unit 5 is disposed between the bearing 17 or bearing brackets 18, or in the region of the electromagnetic drive system, respectively. Separate imbalance weights 5 can optionally also be present along the rotation axis so as to be outside the bearing brackets 18 or the electromagnetic drive system, respectively.

In the first variant according to FIG. 1, the rotor 2 of the electric motor 1, configured as an asynchronous motor, is configured so as not to be symmetrical in relation to the rotation axis but occupies only approximately half of the circular cross section. This means that the rotor 2 extends only across approx. 180° of the circumference of the circle, the other half of the cross section comprising only air 6 or being configured as a recess 6 in the context of the invention, respectively, no material/metal and electromagnetic drive components thus being present. Accordingly, the center of gravity, or the center of the cross-sectional area, respectively, is mounted so as to be eccentric, or provided so as to be eccentric with a spacing from the rotation axis, respectively. An advantageous, relatively large imbalance is thus generated, which in the operation, or at a rotating rotor 2, respectively, leads to the electric motor 1 advantageously generating vibrations, or being able to be used as a vibrator/oscillation exciter, respectively.

By virtue of the rotor 2 according to FIG. 1 extending only across approx. 180° of the circumference of the circle, this electric motor 1 has a torque which is about half the torque of an electric motor 1 in which the electromagnetic drive system would be present on the entire circumference. Advantageous variant of this type, having an electromagnetic drive system on the entire circumference, is illustrated in FIG. 2. It can thus be readily seen in FIG. 2 that the so-called return openings extend across the full 360° of the cross section of the rotor 2, this generating an advantageous torque or a relatively high motor output, respectively.

In this second variant according to the invention, the recess 6, or the air 6, respectively, is enclosed entirely by the rotor 2, or a rotor casing, respectively. An advantageous imbalance 5 according to the invention is also realized herewith.

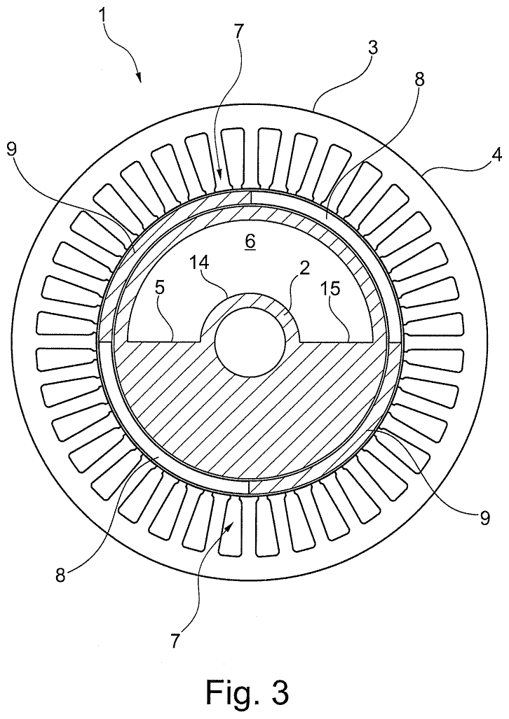

In the third variant according to FIG. 3 the electric motor 1 is configured as a synchronous machine having permanent magnets 7 which are disposed on the circumference. In a highly schematic manner, two south poles 8 of the permanent magnets 7 are illustrated as white areas and two north poles 9 of the permanent magnets 7 are illustrated as black areas in FIG. 3. Accordingly, a total of four poles are present which in practice is certainly rather rare. However, this is only intended to illustrate the principle because electric motors of this type in practice usually have many permanent magnets 7 and thus many poles.

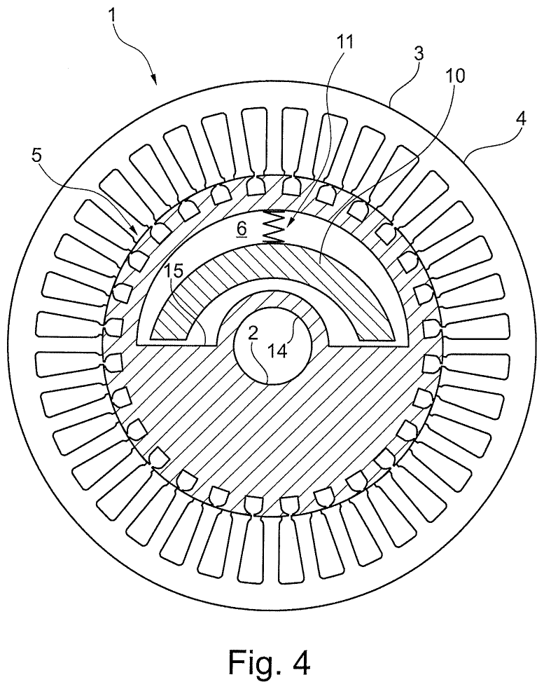

In the fourth variant according to FIG. 4 the rotor 2 again has a recess 6 or air 6, respectively, which is completely enclosed by the rotor 2 or the rotor casing, respectively. An advantageous imbalance 5 according to the invention is also realized herewith. Moreover, a separate weight 10 is however disposed within the recess 6 or the air 6, respectively, said separate weight 10 being held/positioned by a spring 11 which is aligned in a radial direction. Because the weight 10 does not have a circular shape, said weight is also configured as an imbalance 5 in the context of the invention and disposed along the rotation axis so as to be between the two bearing brackets or bearings, respectively, in the region of the electromagnetic drive system.

The weight 10 is advantageously adjusted in the radial direction as a function of the rotating speed of the rotor 2 as well as of the spring force. The effective imbalance mass thus decreases as the rotating speed increases because the centrifugal force pushes the weight 10 radially outward in the direction of the rotor casing. As the rotating speed decreases, the weight 10 “travels” back in the direction of the rotation axis or the center, respectively. An advantageous adaption/variation of the effective imbalance mass or the oscillation excitation, respectively, can be implemented herewith.

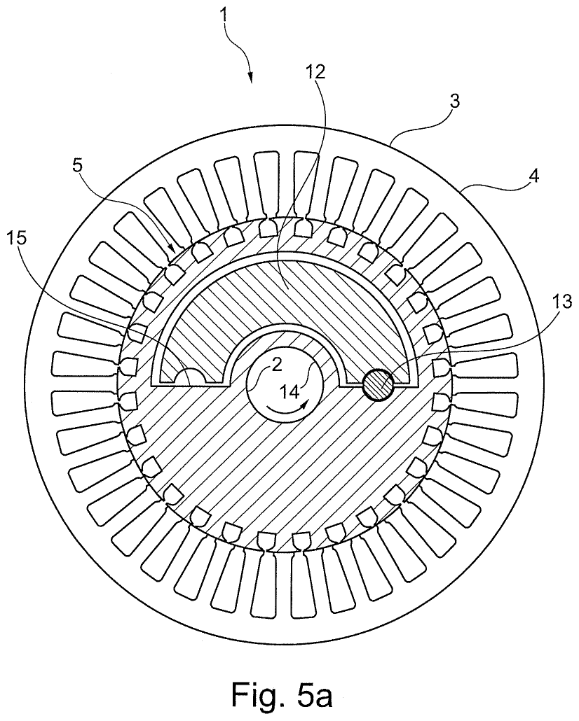

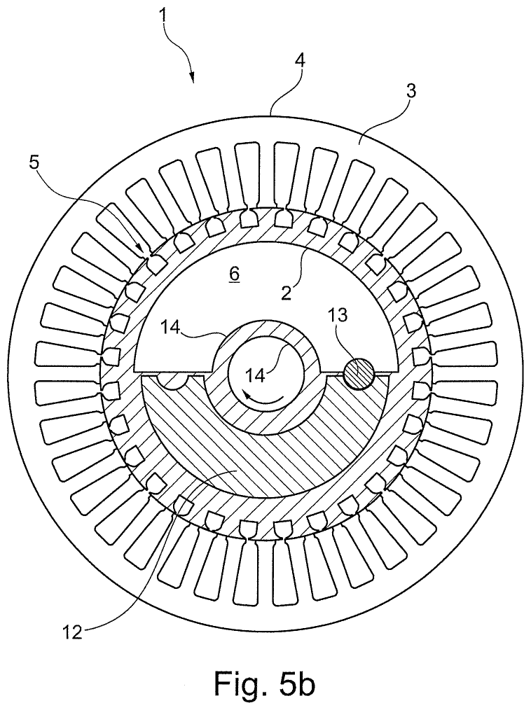

In the fifth variant according to FIG. 5, a separate weight 12 is again present, said weight 12 however not being disposed within the recess 6 of the laminated rotor core but being axially offset, for example along the rotation axis in a free void, or another plane/layer, respectively, between two laminated cores but within a rotor casing which extends over the entire circumference, or between this rotor casing and a rotor shank 14, respectively. As a result of this advantageous void and the advantageous shape of the weight 12, the latter is mounted so as to be rotatable about the rotation axis or the rotor shank 14, respectively.

By virtue of the inertia of the weight 12, the latter as a function of the rotating direction impacts in each case a detent 13 at the end side (cf. FIG. 5a) and FIG. 5b)). The detent 13 is aligned in the direction of the rotation axis, or so as to be parallel to the rotation axis, respectively. The detent 13 is advantageously disposed within the above-mentioned void, or extends between the two above-mentioned laminated cores/layers/planes which are correspondingly spaced apart from one another, respectively. In the position of the weight 12 according to FIG. 5a), a subtraction of the imbalance of the weight 12 conjointly with the imbalance of the laminated rotor core, or the rotor body, respectively, is thus realized and even a complete elimination of the overall imbalance is optionally enabled in the case of an advantageous sizing.

In the position of the weight 12 according to FIG. 5b), an addition of the imbalance of the weight 12 conjointly with the imbalance of the laminated rotor core or the rotor body, respectively, is realized and thus increased. This variability of the total imbalance as a function of the rotating direction of the rotor 2 can be a great advantage in specific fields of application.

In the sixth variant according to FIG. 6, the electric motor 1 is configured according to the invention in such a manner that, according to the variant depicted, a total of two imbalance elements 5 are disposed/fixed on both sides of the electromagnetic drive system, or both sides of the rotor support 15 on/on top of the rotor shaft 16, respectively. According to the invention, these two weights or imbalance elements 5, respectively, are disposed between the two bearings 17 or ball bearings 17, respectively, and between the two bearing brackets 18 of the motor housing 4. Consequently, the two weights or imbalance elements 5, respectively, are disposed and protected within the mounting of the rotor shaft 16 and moreover also within the motor housing 4 or in the interior of the latter, respectively.

1. An oscillation excitation device for producing oscillations and/or vibrations, comprising:
an electric motor having a stator unit and having a rotor unit which is rotatable about a rotation axis and which has at least one rotor shaft;
at least a first bearing unit and a second bearing unit that are configured to rotatably support at least one of the rotor shaft and the rotor unit, wherein
the electric motor has at least one electromagnetic drive system that is disposed between the first bearing unit and the second bearing unit, and further comprising
at least one rotatable imbalance unit that is configured to produce an imbalance, wherein the imbalance unit is disposed, at least in part, between the first bearing unit and the and the second bearing unit.

2. The device as claimed in claim 1, wherein the rotor shaft is configured as an imbalance unit.

3. The device as claimed in claim 1, wherein the rotor unit has at least one support unit that is configured to support rotor components of the electromagnetic drive system.

4. The device as claimed in claim 3, wherein the support unit is configured as an imbalance unit.

5. The device as claimed in claim 1, wherein the imbalance unit is disposed at least in part within a motor housing of the electric motor.

6. The device as claimed in claim 1, wherein the imbalance unit comprises at least one first eccentric element, and wherein a first spacing is provided between a first center of gravity of the first eccentric element and the rotation axis.

7. The device as claimed in claim 6, further comprising at least one adjustment unit which is configured to vary the first spacing between the first center of gravity of the first eccentric element and the rotation axis.

8. The device as claimed in claim 6, wherein the adjustment unit comprises at least one restoring spring element that is configured to produce a restoring force which is, at least in part radially aligned with the first eccentric element and which acts on the first eccentric element.

9. The device as claimed in claim 6, wherein the imbalance unit comprises at least the first eccentric element and a second eccentric element which has a second center of gravity, wherein the second center of gravity is, at least temporarily, disposed so as to be different from the first center of gravity of the first eccentric element.

10. The device as claimed in claim 9, wherein at least one of the first eccentric element and the second eccentric element is configured as an eccentric element which is rotatable about at least one of the rotation axis and the rotor shaft.

11. The device as claimed in claim 1, further comprising at least one detent for the for the eccentric element, wherein the detent is rotatable about at least one of the rotation axis and the rotor shaft.

12. A compactor for compacting soil or concrete engineering or construction site engineering or foundry technology or sorting objects, the compactor comprising:
an oscillation excitation device for producing oscillations and/or vibrations, the oscillation device including
an electric motor having a stator unit and having a rotor unit which is rotatable about a rotation axis and which has at least one rotor shaft;
at least a first bearing unit and a second bearing unit that are configured to rotatably support at least one of the rotor shaft and the rotor unit, the electric motor having at least one electromagnetic drive system that is disposed between the first bearing unit and the second bearing unit; and
at least one rotatable imbalance unit hat is configured to produce an imbalance, wherein the imbalance unit is disposed, at least in part, between the first bearing unit and the and the second bearing unit.
